(19) United States
(12) Patent Application Publication
(10) Pub. No.: US 2010/0018095 A1
(43) Pub. Date: Jan. 28, 2010

(54) Pivotable support for advertising media

(75) Inventor: Patrick Molla, GATINEAU (CA)

Correspondence Address: HUDAK, SHUNK & FARINE, CO., L.P.A., 2020 FRONT STREET, SUITE 307, CUYAHOGA FALLS, OH, 44221, US

(73) Assignee: SOLIFLEX CORPORATION INC., GATINEAU (CA)

(21) Appl. No.: 12/460,231

(22) Filed: Jul. 15, 2009

(30) Foreign Application Priority Data
Jul. 24, 2008 (CA) 2634935

(51) Int. Cl. G09F 15/00

(52) U.S. Cl. 40/606.16; 40/606.01

(57) ABSTRACT

A pivotable support for an assembly for display of advertising media includes a main body that has means for attachment to a surface or post and a rotatable member configured to rotate with respect to the main body. The rotatable member has a means for releasably holding an arm that holds the advertising medium. The arm extends outwardly from an exterior surface of the rotatable member. Rotation of the rotatable member in either direction under wind force against the advertising medium held by the arm causes swinging movement of the arm in either direction away from a resting position of the rotatable member. The assembly also includes a means for biasing rotation of the rotatable member towards the resting position. This means for biasing is attached to the rotatable member and to the main body.

### CROSS REFERENCE TO RELATED APPLICATIONS

This application claims the benefit of priority to Canadian patent application Serial No. 2,634,935 filed Jul. 24, 2008.

### FIELD OF THE INVENTION

The present invention relates to advertising media and more particularly to a support for an arm used for holding advertising media in an assembly configured for attachment to a post or flat surface.

### BACKGROUND OF THE INVENTION

Display devices useful for mounting temporary advertising messages outdoors on supporting structures such as posts or walls where the message is readily noticed by people are commonplace. Advertising media used in such displays include signs or notices printed on sheets of fabric, paper, plastic or any other medium appropriate for printing and display of advertising messages. Because of the outdoor location of such advertising displays, it is advantageous if the components used in for construction of the displays are resistant to weather or protected from the effects of weather. In particular, wind applies loads and then relaxes loads on the advertising medium and its supporting structure on a regular basis. Fasteners or other similar means will often be loosened by the repeated loads applied to the supporting structure of the advertising medium by the changes in wind, causing the display assembly to become loosened and potentially disengaged from the supporting structure. Alternatively the advertising medium may become torn or otherwise damaged by strong winds, or excessive stress will be placed on the support structure as wind loads on the advertising medium are passed directly to the structure.

Current mounting techniques for vertical displays of advertising media such as banners include mounting such banners with the top horizontal edge of the banner as well as the bottom horizontal edge each having a hem running the width of the banner and thereby allowing an arm to be inserted into the sleeve created by the hem. This type of mounting may be of permanent nature i.e. a steel support arm being perpendicularly welded to the post. The arm may also possibly be of a removable with a fibreglass rod or steel tube inserted into a female opening.

Commonly used vertical mounting systems for advertising media employ brackets with fiberglass rod arms and brackets with steel tube arms. The fibreglass arms are often preferred since they offer more flexibility, thereby permitting a limited cushioning of wind gusts although not offering enough flexibility to spill off high wind forces exerted against the advertising medium. High winds can create strong forces and without the capability of the advertising medium being able to tip with and deflect the wind, these forces are directly transferred to the hems, arms, bracket bases and to the supporting structure In such instances, wind gusts often result in tearing and damage to the advertising medium and occasionally, cause structural damage to the post.

U.S. Pat. Nos. 6,192,611, and 6,378,820 describe banner support assemblies having banner support arms which are deflectable using a spring mechanism which is in direct contact with the arms. This provides a mechanism by which part of the wind forces are absorbed by the springs. The banner arms are thus enabled to move and cause wind to deflect from the banner. U.S. Pat. No. 6,192,611 discloses a banner support assembly with banner arms connected to supports with springs having their axes disposed in the same plane as the banner arms. In this manner, the springs act as joints for the arms which allow the banner arms to bend in any direction under force of the wind. This arrangement subjects the springs to a constant force of gravity acting on the banner arms and is expected to weaken the tension of the springs to their normal biased position along their axes. Furthermore, the force of wind on a banner held by this assembly may cause the banner arms to bend independently with respect to each other, causing twisting of the banner, particularly if the wind forces are unequally distributed upon the banner. U.S. Pat. No. 6,378,820 discloses a banner assembly having fixed banner arms. The springs are connected to the banner via a housing which is disposed in the same plane as the banner. The springs of this assembly act to provide a constant force on the banner, stretching it to keep it taut. The upper springs attached via the upper arm stretch the banner upwards and the lower springs attached via the lower arm stretch the banner downwards. These constant downwards or upwards forces on the springs would be expected to weaken the tension forces that they can provide over time.

A need exists for the provision of a reliable support assembly for advertising media which makes mounting an advertising medium onto supporting members easy and time efficient and yet provides for the requisite durability and reliability in order to maintain adequately support and tautness of the advertising medium on its supporting components, thereby ensuring premium appearance of the advertising message.

### SUMMARY OF THE INVENTION

The present invention overcomes many of the above noted shortcomings of prior devices.

In one aspect of the invention is provided a pivotable support for an assembly for display of advertising media. The support includes a main body with a means for attachment to a flat surface or post and a rotatable member configured to couple to the main body and to rotate with respect to the main body. The rotatable member includes a means for holding an arm for attachment of an advertising medium. When the support is in use, the arm extends outwardly from the rotatable member. Rotation of the rotatable member in either direction under wind force against the advertising medium held by the arm causes swinging movement of the arm in either direction away from a resting position. The support includes means for biasing rotation of the rotatable member towards the resting position. The means for biasing is attached to the rotatable member and to the main body.

In another aspect, the invention provides an assembly for holding an advertising medium. This assembly includes a pair of supports, each of which includes a main body with a means for attachment to a flat surface or post and a rotatable member configured to couple to the main body and to rotate with respect to the main body. The rotatable member includes a means for holding an arm for attachment of an advertising medium. When the support is in use, the arm extends outwardly from the rotatable member. Rotation of the rotatable member in either direction under wind force against the advertising medium held by the arm causes swinging movement of the arm in either direction away from a resting position. The support includes means for biasing rotation of the rotatable member towards the resting position. The assembly includes a first arm linked to one of the supports and a second arm linked to the other support. An advertising medium is connected at one end to the first arm and to the second arm at an opposing end. In this assembly, the advertising medium retains substantially constant tension between the first and second arms as the rotatable members rotate to induce swinging motion of the first and second arms away from the resting position.

In another aspect is provided a kit of parts for constructing an assembly for holding an advertising medium. The kit of parts includes a pair of supports as described above, a pair of arms configured for attachment to the means for releasably holding an advertising medium, and instructions for assembling the assembly on a wall or post.

It will be understood that the arm supports, and assembly, in accordance with the present invention, when mounted for example on a post, will permit the advertising medium to pivot, with respect to the post, when wind forces on the advertising medium overcome the bias of the biasing means, thereby allowing wind to be deflected or spilled from the advertising medium, reducing wind forces thereon, reducing the wear and tear on the advertising medium and allowing the advertising medium to return to its normal resting position with respect to the post the post when the wind forces have appropriately diminished, under urging from the biasing means.

### BRIEF DESCRIPTION OF THE DRAWINGS

These and other advantages of the invention will become apparent upon reading the following detailed description and upon referring to the drawings in which:

FIG. 1 is a perspective view of an assembly in accordance with the present invention, holding an advertising medium on a vertical post;

FIG. 2 is a perspective view of a support, in accordance with the present invention, for one of the arms of the assembly of FIG. 1;

FIG. 3 is a side view of the support of FIG. 2;

FIG. 4 is a section view of the support of the FIG. 2;

FIG. 5 is a side view, similar to that of FIG. 3, of a support in accordance with the present invention, but partly broken away, illustrating the operation of the rotatable member when urged away from its resting position under wind force.

While the invention will be described in conjunction with the illustrated embodiments, it will be understood that it is not intended to limit the invention to such embodiments. On the contrary, it is intended to cover all alternatives, modifications and equivalents as may be included within the scope of the invention as defined by the appended claims.

### DETAILED DESCRIPTION OF EMBODIMENTS

In the drawings, similar features have been given similar reference numerals.

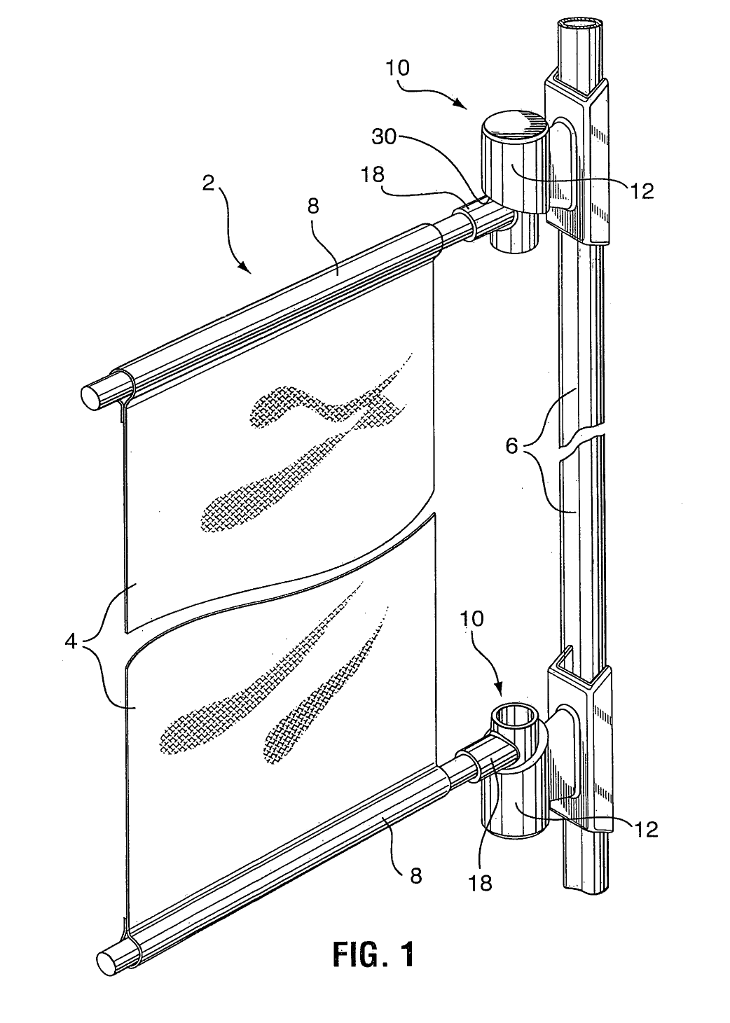

Turning to FIG. 1, there is illustrated an embodiment of a support assembly 2 supporting an advertising medium 4 on a vertical post 6 in taut vertical fashion. The advertising medium 4, may be a sign, flag, banner or any such component constructed of durable material including but not limited to materials such as fabric, plastic, durable paper, cardboard or the like, which are suitable for display of an advertising message.

The support assembly 2 of this embodiment may also be supported on a horizontally disposed post or to other generally flat surfaces including vertical surfaces (such as walls) or horizontal surfaces (such as ceilings or roofs) by attachment of the assembly using means known to those skilled in the art. The assembly 2 comprises a pair of arms 8, which are held by a pair of supports 10, in accordance with certain embodiments of the present invention.

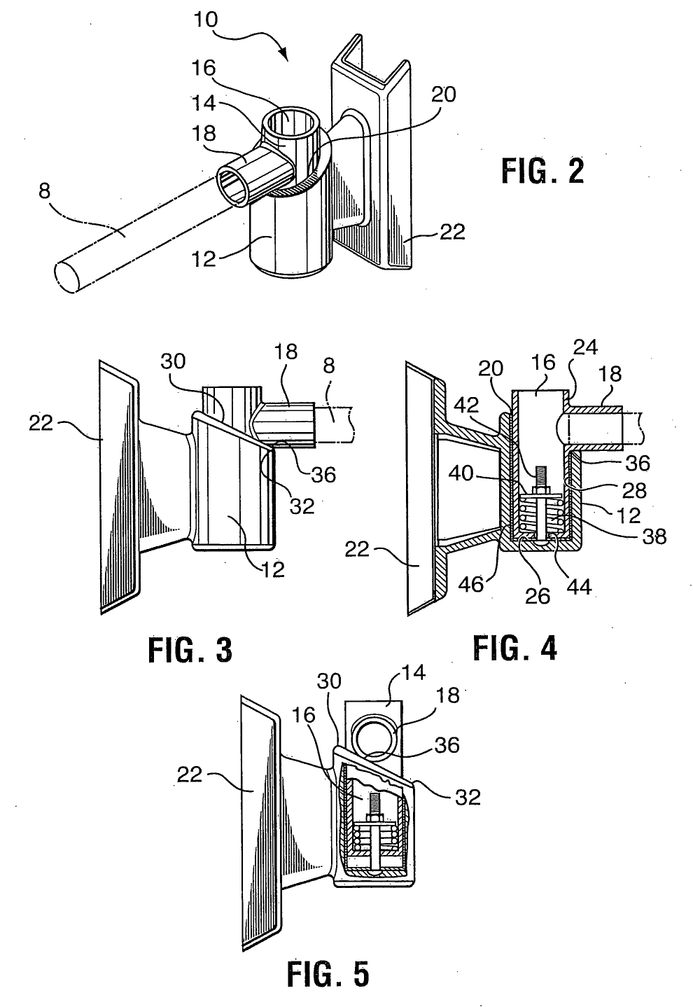

As can be seen in FIG. 2, in certain each support 10 comprises a main body which, in these example embodiments, is provided with an extended portion 12. The extended portion 12 includes a means for coupling a rotatable member 14. In the embodiments shown in FIGS. 1 to 5, the extended portion 12 is shown as a socket 20 and the rotatable member 14 is shown as a plug. However, the invention described herein is not intended to be limited to including a socket 20. Other arrangements of the extended portion 12 are possible, for example, a ring-like structure can be formed in the extended portion and the rotatable member 14 is retained by the upper edge of the ring while the lower end of the rotatable member is exposed and extends from the lower end of the ring. Other components to be described below would thus be exposed instead of contained within the socket 20.

In these example embodiment shown in FIGS. 1 to 5, the extended portion 12 and the rotatable member 14 are both substantially cylindrical. In other embodiments, the main body and the rotatable member 14 may be constructed in other shapes.

In the embodiments shown in FIGS. 1 to 5, the rotatable member 14 is provided with an outwardly extending means for releasable attachment to an arm 8, which in this embodiment is shown as linkage member 18. The linkage member 18 may be integrally formed in the rotatable member 14 or be a separate member attached thereto by attachment means known to those skilled in the art.

In the embodiment illustrated in FIGS. 2 to 5, the linkage member 18 is shown as a hollow cylinder or sleeve having a configuration appropriate for insertion of an arm 8 into the hollow portion of the linkage member 18. Appropriate alternative means for providing this linkage will be readily apparent to those skilled in the art. For example, the linkage member 18 could be a solid rod-like projection and the arm 8 could be a hollow arm configured to accommodate the solid projection therewithin. Other connections may be made using extra parts such as rod or pipe connectors, brackets or the like. Such alternative means for linking the arm 8 to the support 10 are within the scope of the invention.

In this example embodiment, the linkage member 18 is positioned near the upper end of the rotatable member 14 where it releasably provides a linkage to one of the ends of the arm 8.

In this example embodiment, support 10 is provided with backing 22 appropriately configured for securely mounting the support to a post 6 or other surface for the assembly 2. The mounting connection may be effected using bolts, screws, post rings or other fastening means known to those skilled in the art.

In one embodiment, as described above, the extended portion 12 is defined by a socket 20 as shown in FIGS. 1 to 5 and the walls of the socket 20 include a base 26 with a side wall 28 circumscribing the base 26.

In the example embodiments shown in FIGS. 1 to 5 wherein the coupling means is a plug and socket arrangement, the main body defines an edge 30 of the socket 20 which has an angled rotation path with respect to the axis of rotation of the rotatable member. In these embodiments, the angled rotation path along the edge 30 represents a circumferentially-slanted edge extending between a low point 32, progressively upwardly, in similar fashion on either side of this low point 32. The edge 30 functions as the angled rotation path.

In this example embodiment, socket 20 and cylindrical rotatable member 14 are configured so that the lower end of the rotatable member 14 can be pivotally and fixedly seated in socket 20. It will be seen in FIGS. 2 and 4, for example, that a lower portion 36 of linkage member 18 rests on low point 32 when in a normal resting position with the arms 8 (FIG. 1) extending directly outwardly, from the socket 20, substantially perpendicular to the backing 22. When rotatable member 14 is seated in the resting position in socket 20, its lower end may be supported on socket base 26. However, because of the progressive upward contour of edge 30 on either side of point 32 and because the lower portion 36 of the linkage member 18 rests upon the edge 30, as rotatable member 14 pivots within socket 20 in either direction away from this normal position (for example under the force of wind against the advertising medium 4) the lower portion 36 of the linkage member 18 resting upon the edge 30 causes the rotatable member 14 to be progressively raised in socket 20 with respect to the base 26 of the socket 20. When the rotatable member 14 pivots in either direction away from the resting position within socket 20, the linkage member 18 travels progressively up along the edge 30 and the lower end of the rotatable member 14 moves away from the base 26 of the socket 20.

In certain example embodiments, the rotatable member 14 and socket 20 arrangement is provided with a biasing means which urges the rotatable member 14 to remain in the resting position within the socket 20 as described above wherein the lower portion 36 of the linkage member 18 rests upon low point 32 on edge 30 of the socket mouth (see FIGS. 4 and 5). The biasing means is shown as a coil spring 38 positioned within a cavity 16 in the rotatable member 14 as illustrated. One end of the coil spring 38 is secured to the base or the side wall of a cavity 16 of rotatable member 14 and the other end is secured to a self-locking nut 40 which is in turn secured to a bolt 42. The bolt 42 extends through an aperture 44 in the rotatable member 14. The extending portion of the bolt 42 is secured to the base 26 of the socket 20.

In other embodiments, other arrangements of the biasing means are possible. For example, in the embodiment described above where the extended portion 12 is provided a ring instead of socket 20, a lower portion of the rotatable member can be attached to one end of the biasing means and the other end of the biasing means can be attached to a point on the main body, thereby providing an anchor point for the biasing means. In such embodiments, the biasing means is exposed instead of being housed within the socket 20 of the embodiments illustrated in the Figures. Furthermore, it will be appreciated that other types of biasing means which are well known to those skilled in the art will be applicable to embodiments described herein. For example, instead of a coil spring, a biasing connector formed of rubber or a shape memory alloy could also be used as a biasing means. Such alternative biasing means are within the scope of the invention.

Returning now to the embodiments of FIGS. 1 to 5, in operation, the bias provided by coil spring 38 permits rotatable member 14 to pivot against that bias within socket 20, only when the force of wind on the advertising medium 4 exceeds the biasing force. At this point, the pivoting of the rotatable member 14 within the socket 20 causes the linkage member 18 to move along the slanted edge 30. This motion of the linkage member 18, in each member of the pair of supports 10 in turn, causes the arms 8 to swivel concurrently and cause the advertising medium 4 to change its angle with respect to the force of the wind. The change in angle allows wind to deflect or spill from the advertising medium 4 thereby reducing the force of the wind acting on the advertising medium 4. This reduction in wind force eventually is overcome by the opposing bias provided by the biasing means which returns rotatable member 14 to its normal position in socket 20 when the wind pressure lessens. The force of the wind causes rotation of the rotatable members in both of the supports 10 and thus, the linkage members travel along the angular path, which in these example embodiments, represents a circumferentially slanted edges 30 of their respective sockets 20 along a partially helical trajectory, causing both arms 8 and the advertising medium 4 to move sideways and upwards. When the aforementioned reduction in wind force is attained, the force of gravity tends to cause the linkage members 18 slip back down along the circumferentially slanted edges 30. Thus, gravity provides additional biasing force to return the rotatable members 14 to their resting positions.

This motion provides a visually attractive movement to the entire assembly because the advertising medium is not reactively responding to wind forces with quick jerking motions caused by the strong counter forces applied directly to the arms as described in the prior art assemblies. In contrast, the wind forces cause smooth rotating movement of the rotatable members 14 along the angular path along the edges 30 of the socket 20, thereby causing the arms 8 to swing along a predetermined partially helical trajectory before the biasing means and the angular deflection of the wind reduce the wind force on the advertising medium 4. An additional advantage provided by the prevention of quick jerking motion is to reduce the wear and tear on the advertising medium and the components of the support as well as preventing these forces from being transmitted to the post or flat surface.

It will be understood that the strength of biasing means or coil spring 38 may be adjusted, for example by appropriate positioning of lock nut 40 on bolt 42, depending upon the range of wind forces to be experience by any particular advertising medium 4. Other means for adjustment of the biasing means are possible in these and other embodiments of the invention.

As can be seen in FIG. 4, it is preferred that a liner 46 of a friction reducing material can be provided within socket 20, between the inner sides of the side wall 28 of the socket 20 and the corresponding outer surfaces of the rotatable member 14. This will minimize the chances of the rotatable member 14 from seizing and preventing the pivoting of the rotatable member 14 within socket 20.

In operation as can been seen in FIG. 1, a pair of supports 10 for arms 8 are positioned, at spaced locations, in substantially similar orientations so that the openings of sockets 20 and their upper edges 30 face in the same direction. In this example embodiment the arms 8 are held in parallel orientation, one directly over the other.

The assembly 2 and supports 10 are intended mainly for attachment to posts and to vertical or horizontal buildings or any upstanding support surface in an environment that is subject potentially strong wind forces.

One skilled in the art will recognize that while the embodiments described above generally relate to a vertically disposed assembly, other embodiments of horizontally disposed assemblies are within the scope of the invention. In such embodiments, the support members would be attached to a horizontal wall surface such as a ceiling or a roof, or horizontally disposed post in the same plane such that the linkage members and arms linked thereto extend vertically downwards or upwards.

One skilled in the art will also recognize that alternative assemblies may also be constructed using the pivotable support described herein. For example, a single pivotable support as described herein may be used in combination with an alternative means for attachment of an advertising medium to a flat surface or post which may or may not include an arm for attachment of another portion of the advertising medium. For example, a single support could be used to support an upper edge of an advertising medium while another portion of the advertising medium such as the lower edge could be attached to a post or flat surface or otherwise supported by alternative means such as a commonly used flagpole ring known to those skilled in the art. Such alternative assemblies are within the scope of the present invention.

In summary, the support to enables the plane of the advertising medium, to move along a partially helical trajectory with respect to the wind direction (with each rotatable member of each support pivoting in its corresponding socket) to spill the wind from the advertising medium and thereby reduce the wind force on the advertising medium, the support assembly and the post or other support structure. The assembly according to the present invention requires less hardware to support the advertising medium and acts effectively to dissipate excessive wind forces.

Thus, it is apparent that there has been provided in accordance with the invention a pivotable support for display of advertising media that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A pivotable support for an assembly for display of advertising media comprising:
a main body having means for attachment to a flat surface or post;
a rotatable member configured to couple to said main body and to rotate with respect to said main body, said rotatable member having a means for holding an arm for holding an advertising medium, said arm extending outwardly from said rotatable member, wherein rotation of said rotatable member in either direction under wind force against said advertising medium held by said arm causes swinging movement of said arm in either direction away from a resting position;
means for biasing rotation of said rotatable member towards said resting position, said means for biasing attached to said rotatable member and to said main body; and
wherein said main body defines an edge with an angled rotation path with respect to an axis of rotation of said rotatable member.

2. The support of claim 1, wherein said means for biasing rotation of said rotatable member is adjustable to increase or decrease biasing force.

3. The support of claim 1, wherein said means for releasably holding said arm comprises a linkage member.

4. The support of claim 3, wherein said linkage member extends substantially perpendicularly outward from said exterior surface of said rotatable member.

5. The support of claim 3, wherein said linkage member is a rigid sleeve integrally formed in said rotatable member and configured to receive an end of said arm.

6. The support of claim 3, wherein said linkage member sits upon said edge and travels along said angled rotation path when said rotatable member rotates away from said resting position.

7. The support of claim 1, wherein said means for biasing rotation is a coil spring connected to said rotatable member and to a bolt connected to said main body.

8. The support of claim 7, wherein said coil spring is connected to said bolt via an adjustable self-locking nut, whereby adjustment of said nut on said bolt adjusts the force of said coil spring.

9. The support of any one of claims claim 1, wherein said resting position is located at the lowest point along said angled rotation path.

10. The support of claim 1, wherein said edge of said angled rotation path defines the mouth of a socket disposed in said main body or an indentation on an inner or outer wall of said main body.

11. The support of claim 1, further comprising: a friction reducing material positioned between the surfaces of said main body and said rotatable member.

12. The support of claim 11, wherein said friction reducing material is plastic.

13. An advertising assembly comprising:
a main body having means for attachment to a flat surface or post, a rotatable member configured to couple to said main body and to rotate with respect to said main body, said main body defining an edge with an angled rotation path with respect to an axis of rotation of said rotatable member, said rotatable member having a means for holding an arm for holding an advertising medium, said arm extending outwardly from said rotatable member, wherein rotation of said rotatable member in either direction under wind force against said advertising medium held by said arm causes swinging movement of said arm in either direction away from a resting position;
a first arm, said first arm linked to a first rotatable member of a first support of said pair of supports and a second arm linked to a second rotatable member of a second support of said pair of supports; and
an advertising medium connected at one end to said first arm and to said second arm at an opposing end, said advertising medium retaining substantially constant tension between said first and second arms as said first and second rotatable members rotate under wind force to induce swinging motion of said first and second arms away from said resting position to reduce said wind force against said advertising medium.

14. The assembly of claim 13, wherein each of said pair of supports comprises a main body having means for attachment to a flat surface or post; a rotatable member configured to couple to said main body and to rotate with respect to said main body, said rotatable member having a means for holding an arm for holding an advertising medium, said arm extending outwardly from said rotatable member, wherein rotation of said rotatable member in either direction under wind force against said advertising medium held by said arm causes swinging movement of said arm in either direction away from a resting position; means for biasing rotation of said rotatable member towards said resting position, said means for biasing attached to said rotatable member and to said main body; and wherein said main body defines an edge with an angled rotation path with respect to an axis of rotation of said rotatable member.

15. A kit of parts for constructing an assembly for display of advertising media comprising:
a pair of supports comprises a main body having means for attachment to a flat surface or post; a rotatable member configured to couple to said main body and to rotate with respect to said main body, said rotatable member having a means for holding an arm for holding an advertising medium, said arm extending outwardly from said rotatable member, wherein rotation of said rotatable member in either direction under wind force against said advertising medium held by said arm causes swinging movement of said arm in either direction away from a resting position; means for biasing rotation of said rotatable member towards said resting position, said means for biasing attached to said rotatable member and to said main body; and wherein said main body defines an edge with an angled rotation path with respect to an axis of rotation of said rotatable member;
a pair of arms configured for attachment to said means for releasably holding an advertising medium; and
instructions for assembling said assembly on a flat surface or post.
